(19) United States
(12) Patent Application Publication
(10) Pub. No.: US 2024/0063753 A1
(43) Pub. Date: Feb. 22, 2024

(54) SYSTEMS AND METHODS FOR WIND-DISPLACED CLEANING OF SOLAR COLLECTORS

(71) Applicant: DUSTOSS LTD., Har Adar (IL)

(72) Inventors: Yoel SEFI, Har Adar (IL); Hardar SEFI, Har Adar (IL); Lidor MAZOUZ, Har Adar (IL)

(21) Appl. No.: 18/269,556

(22) PCT Filed: Jan. 11, 2022
(86) PCT No.: PCT/IB2022/050184

§ 371 Date: Jun. 25, 2023

Related U.S. Application Data
(60) Provisional application No. 63/135,785, filed on Jan. 11, 2021.

(51) Int. Cl. H02S 40/10; F24S 40/20

(52) U.S. Cl. CPC H02S 40/10; F24S 40/20

(57) ABSTRACT

A method and corresponding control system for operating a tracker mechanism that supports a solar collector so as to enhance the effectiveness of wind-displaced cleaning elements on the solar collector surface. A controller (16) receives information indicative of current wind conditions, determines a cleaning orientation of the solar collector (10) that will enhance cleaning of the collector surface by the wind-displaced cleaning element (100) under the current wind conditions, and actuates at least one actuator (12) to bring the solar collector to the cleaning orientation. Also provided is a cleaning system for solar collectors which provides advantageous mechanical properties in the mounting of wind-displaceable cleaning elements to minimize localized stress at the attachment points which might lead to tearing and which facilitates replacement of the cleaning elements.

### FIELD AND BACKGROUND OF THE INVENTION

The present invention relates to solar energy and, in particular, relates to systems and methods for wind-displaced cleaning of solar collectors.

It is known to employ wind-displaced cleaning elements to displace dust and other dirt from the surface of a solar collector, such as photo-voltaic (PV) panels and mirrors of heliostat systems, in order to improve efficiency.

One particular advantage of wind-displaced cleaning elements is the saving in labor costs of cleaning, since the wind-displaced cleaning elements are operated without human involvement. Since, however, the effective lifetime of a lightweight wind-displaced cleaning element is typically much less than that of the solar collector itself, the labor costs for periodic replacement of the cleaning elements must also be considered. In many cases, the solar collectors are elevated from the ground and/or otherwise inaccessible, which may complicate replacement of cleaning elements.

In some cases, tracking systems are employed in which a solar collector is displaced about one or two axes of rotation during the hours of sunlight in order to maximize efficiency of capture of solar radiation. In the case of PV panels, the efficiency typically varies roughly according to the cosine of the angle of incidence of the sun's rays, so approximate alignment is typically sufficient. In the case of mirrors of a heliostat, precise alignment of each mirror is needed so as to direct incident rays towards a central receiver.

### SUMMARY OF THE INVENTION

The present invention provides systems and methods for wind-displaced cleaning of solar collectors.

According to the teachings of an embodiment of the present invention there is provided, a cleaning system with interchangeable wind-displaced cleaning elements for cleaning one or more solar collector, the system comprising: (a) a pair of fixtures, attached to or integrated with one or more solar collector at spaced-apart locations, each of the fixtures having a first part of an attachment configuration; and (b) a cleaning device comprising a wind-displaceable cleaning element terminating at each end in a clip having a second part of an attachment configuration configured so as to define together with the first part of an attachment configuration a releasable attachment configuration, such that the cleaning device is deployable by attaching each clip to a corresponding one of the fixtures and is removable for replacement by detaching the attachment configuration for each clip, thereby facilitating replacement of the cleaning device by another similar cleaning device.

According to a further feature of an embodiment of the present invention, the wind-displaceable cleaning element is formed at least in part from a ribbon, and wherein each of the clips comprises a ribbon gripper gripping a corresponding end of the wind-displaceable cleaning element.

According to a further feature of an embodiment of the present invention, the ribbon gripper comprises three adjacent elongated elements defining between them two ribbon-gripping slots, a first of the slots being open at a first end and a second of the slots being open at a second end opposite from the first end.

According to a further feature of an embodiment of the present invention, the releasable attachment configuration is disengaged by motion of the clip relative to the fixture in a release direction, and wherein, when the cleaning device is deployed, tension in the cleaning device acts on the clips in a direction which has a negative component along the release direction.

According to a further feature of an embodiment of the present invention, the fixtures are attached to or integrated with side surfaces of the solar collector.

According to a further feature of an embodiment of the present invention, the fixtures are attached to or integrated with rear surfaces of the solar collector.

According to a further feature of an embodiment of the present invention, the attachment configuration is configured to provide angular freedom of motion of the clip when attached to the fixture.

According to a further feature of an embodiment of the present invention, the second part of the attachment configuration includes a closed loop that is engaged by the first part of the attachment configuration.

According to a further feature of an embodiment of the present invention, each of the clips comprises a projecting handle configured to facilitate holding of the clips by a holding tool during attachment to, and detachment from, the fixture.

There is also provided according to the teachings of an embodiment of the present invention, a method of operating a tracker mechanism that supports a solar collector having a collector surface that is cleaned by at least one wind-displaced cleaning element, the tracker including at least one actuator for changing an angular orientation of the solar collector about at least one axis, the tracker further including a controller for controlling the at least one actuator, the controller including at least one processor, the method comprising the steps of: (a) inputting to the controller a dataset sufficient to identify at least a first region of the collector surface that is less clean than a second region of the collector surface; (b) inputting to the controller information indicative of current wind conditions; (c) determining a cleaning orientation of the solar collector that will enhance cleaning of the first region of the collector surface by the at least one wind-displaced cleaning element under the current wind conditions; and (d) actuating the at least one actuator to bring the solar collector to the cleaning orientation.

According to a further feature of an embodiment of the present invention, the dataset includes data of wind conditions and corresponding orientations of the solar collector during a period of operation of the tracker mechanism.

According to a further feature of an embodiment of the present invention, the dataset includes an image of the collector surface, and wherein the controller processes the image to identify the first region.

According to a further feature of an embodiment of the present invention, the information indicative of current wind conditions is derived from a wind sensor configured to sense wind speed and wind direction.

According to a further feature of an embodiment of the present invention, the information indicative of current wind conditions is obtained via a communications network from a weather service.

According to a further feature of an embodiment of the present invention, the controller further receives inputs from at least one sensor from the group consisting of: a humidity sensor;

a radiation sensor; and an air quality or pollution sensor.

According to a further feature of an embodiment of the present invention, the tracker is a single-axis tracker.

According to a further feature of an embodiment of the present invention, the tracker is a dual-axis tracker.

According to a further feature of an embodiment of the present invention, the solar collector is a photovoltaic panel.

According to a further feature of an embodiment of the present invention, the solar collector is a mirror.

According to a further feature of an embodiment of the present invention, the solar collector is brought to the cleaning orientation exclusively during non-operative hours of the solar collector.

According to a further feature of an embodiment of the present invention, the dataset includes data sufficient to determine or predict a drop in efficiency of the solar collector due to accumulated dirt, and wherein the controller further comprises a decision-making subsystem configured to interrupt operation of the solar collector to bring the collector to the cleaning orientation when an efficiency improvement due to cleaning is expected to outweigh losses due to disruption of normal tracking.

There is also provided according to the teachings of an embodiment of the present invention, a method of operating a tracker mechanism that supports a solar collector having a collector surface that is cleaned by at least one wind-displaced cleaning element, the tracker including at least one actuator for changing an angular orientation of the solar collector about at least one axis, the tracker further including a controller for controlling the at least one actuator, the controller including at least one processor, the method comprising the steps of: (a)
inputting to the controller information indicative of current wind conditions; (b) determining a cleaning orientation of the solar collector that will enhance cleaning of the collector surface by the at least one wind-displaced cleaning element under the current wind conditions; and (c) actuating the at least one actuator to bring the solar collector to the cleaning orientation.

### BRIEF DESCRIPTION OF THE DRAWINGS

The invention is herein described, by way of example only, with reference to the accompanying drawings, wherein:

FIGS. 1A and 1B are schematic illustrations of solar collector arrangements including a single-axis and a dual-axis tracker mechanism, respectively, for implementation of an aspect of the present invention;

FIG. 2 is a block diagram of a system for operating a tracker mechanism that supports a solar collector having a collector surface that is cleaned by at least one wind-displaced cleaning element, according to an aspect of the present invention;

FIG. 3 is a front view of a solar collector fitted with a cleaning system according to a further aspect of the present invention;

FIG. 4A is a partial isometric view of the solar collector of FIG. 3 illustrating a form of attachment of a wind-displaceable cleaning device to the collector;

FIGS. 4B and 4C are enlarged views of the region of FIG. 4A designated IV, showing a releasable attachment configuration in an attached and a detached state, respectively;

FIGS. 5A and 5B are isometric views of a clip and a fixture from the releasable attachment configuration of FIG. 4B, shown prior to and after engagement, respectively;

FIG. 5C is an end view of the fixture from FIG. 5A;

FIG. 5D is a cross-sectional view taken along the line V-V in FIG. 5C;

FIG. 6 is an isometric view of a clip and a fixture from an alternative implementation of a releasable attachment configuration for use with the solar collector of FIG. 3, shown prior to engagement;

FIG. 7A is an isometric view of an implementation of the cleaning system of the present invention employing the clip and fixture of FIG. 6, shown as if deployed on a solar collector, but with the solar collector omitted for clarity;

FIG. 7B is an enlarged view of the region of FIG. 7A designated VII;

FIGS. 8A and 8C are isometric views illustrating a variant implementation of the solar collector of FIG. 3 where the solar collector has a small thickness, illustrating an alternative deployment of the attachment configuration; and

FIGS. 8B and 8D are enlarged views of the regions of FIGS. 8A and 8C designated VIII and IX, respectively.

### DESCRIPTION OF THE PREFERRED EMBODIMENTS

The present invention provides systems and methods for wind-displaced cleaning of solar collectors.

The principles and operation of systems and methods according to the present invention may be better understood with reference to the drawings and the accompanying description.

By way of introduction, the present invention provides two distinct aspects, each of which is believed to be of inventive significance in its own right, and which can be used together to advantage. A first aspect of the invention relates to a method and corresponding control system for operating a tracker mechanism that supports a solar collector so as to enhance the effectiveness of wind-displaced cleaning elements on the solar collector surface. A second aspect of the invention relates to a cleaning system for solar collectors which provides advantageous mechanical properties in the mounting of wind-displaceable cleaning elements to minimize localize stress at the attachment points which might lead to tearing and/or facilitates replacement of the cleaning elements. Each aspect of the invention will now be described separately, but it should be appreciated that they are advantageously combined in a single system.

Both aspects of the present invention are applicable to a wide range of solar collectors including, but not limited to, photovoltaic (PV) panels and reflectors (mirrors) of heliostat arrangements. For simplicity of presentation, the invention will be illustrated with reference to a single solar collector or a small group of solar collectors operating as a unit. Where the solar collectors operate as part of a “field” of similar collectors, it will be appreciated that some or all aspects of the control system are advantageously implemented as part of a shared control system that serves multiple solar collectors, as will be clear to a person having ordinary skill in the art.

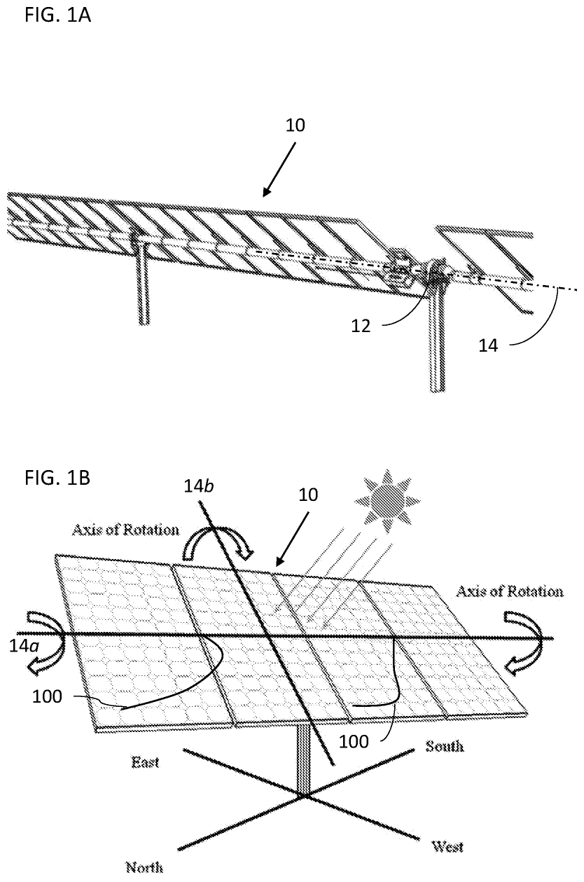

Turning now to the first aspect of the present invention, this relates to a method, and corresponding system, for operating a tracker mechanism that supports a solar collector having a collector surface that is cleaned by at least one wind-displaced cleaning element. Tracker mechanisms can be broadly divided into two classes: single-axis trackers, as illustrated in FIG. 1A, and dual-axis trackers, as illustrated in FIG. 1B. In single-axis trackers, pivoting of the solar collectors 10 by one or more actuator 12 about a single axis 14 is used to reduce the incident angle of the sun's rays of the collector surface as the sun traverses the sky. The rotation axis may be horizontal (as shown), vertical, or at some inclined angle. Although a single-axis tracker cannot precisely follow the trajectory of the sun across the sky at different times of the year, it may be sufficient to provide significant enhancement of efficiency in capturing morning and evening hours of solar energy, particularly in PV applications. A dual-axis tracker, illustrated schematically in FIG. 1B, employs actuators (not shown) to rotate solar collectors 10 about two axes of rotation 14a and 14b, thereby allowing full tracking of the sun across the sky. In PV systems, this offers a further potential increase in efficiency. In heliostat applications, dual-axis tracking is typically an essential requirement.

This aspect of the present invention harnesses a particular synergy between the presence of a tracker mechanism and the use of one or more wind-displaced cleaning elements. Specifically, a controller 16 that controls the at least one actuator 12 is configured to orient the solar collector 10 in an orientation which enhances operation of the wind-displaced cleaning element(s) for cleaning the solar collector. It should be noted that this aspect of the present invention is applicable to any type and deployment of wind-displaced cleaning elements. Although it may be used to advantage with the cleaning systems of the second aspect of the present invention described below, it is not limited to such applications. By way of one example, FIG. 1B illustrates an implementation of the invention in the context of cleaning elements that are anchored at only one end.

By way of a basic example, by inputting information regarding the current wind direction and speed, the controller may choose an orientation for the solar collector during hours that are not used for collecting solar radiation (e.g., at night) so as to optimize the cleaning effect of the wind-displaceable cleaning elements. This can be done even without any information as to the current state of the solar collector surface.

In a further example, in an installation in a location where wind conditions are predictably from a certain direction, for example, a predominant westerly wind, the wind-displaced cleaning elements may be effective for cleaning the downwind eastern part of each solar collector, but may be less effective at cleaning the upwind western side of the collector surface. In such a case, the controller may be configured to orient the solar collectors during hours of darkness in an orientation tilted so as to maximize the effect of the wind-displaced elements for cleaning the western part of the surfaces. This may be by tilting the panel so that the western side is sloped downwards, or where the mechanism permits, turning the panel so that the eastern side is upwind (possibly with the panel inverted).

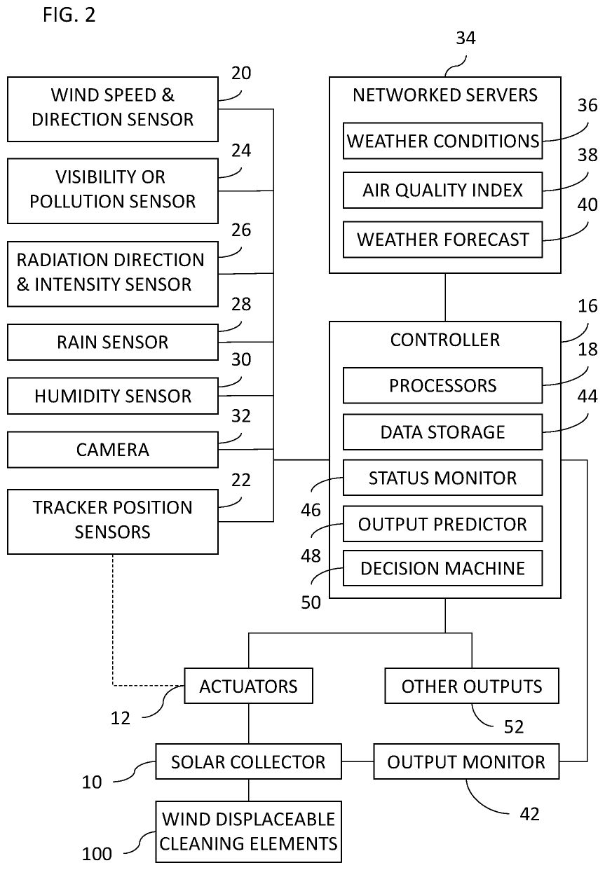

Typically, both the manner in which non-uniformities of the cleaning effect occur and the range of possible corrective actions which may be taken by the system are dependent upon many variables of the weather conditions, other atmospheric conditions, and the history of operation of the system. Accordingly, in particularly preferred implementations of this aspect of the invention, as illustrated in FIG. 2, controller 16 employs one or more processors 18 to process data from various sources and to implement decision logic or artificial intelligence (AI) to select an appropriate course of action, all as will be further detailed below.

In broad terms, a non-limiting preferred implementation of this aspect of the present invention inputs to controller 16 a dataset sufficient to identify at least a first region of the collector surface that is less clean that a second region of the collector surface. Controller 16 also receives information indicative of current wind conditions, and determines a cleaning orientation of the solar collector that will enhance cleaning of the first region of the collector surface by the at least one wind-displaced cleaning element under the current wind conditions. Then, preferably during hours of darkness or optionally under otherwise suitable conditions (discussed further below), the controller 16 actuates the at least one actuator 12 to bring the solar collector 10 to the cleaning orientation.

The dataset indicative of the distribution of dirt on the solar collector surface may include various different types of data from various different sources. Conceptually, the distribution of dirt on the solar collector surface may be estimated by one, or a combination, of three approaches: (A) MODELLING: estimation of dirt distribution based on modeling the dirt accumulation and the cleaning process over time; (B) COMPARATIVE OUTPUT: assessment of the impact on power output from the panel due to dirt on the surface; and (C) SENSORS: direct sensing of the dirt distribution on the surface.

According to the modelling approach, the cleaning effect of the wind-displaced cleaning element(s) is preferably estimated based on data of wind conditions and corresponding orientations of the solar collector during a period of operation of the tracker mechanism. The wind conditions are preferably derived from a local wind speed and direction sensor 20, which may either be located adjacent to the solar collector or may be centralized to a set of collectors or to an entire solar farm. Alternatively, an approximation for the wind conditions can be derived from an online service via networked servers 34 which includes real-time weather condition data 36 for the relevant locale. The orientation of the solar collector over time is typically derived from tracker position sensors 22, such as angular encoders, which may be associated with actuators 12. In some cases, the history of actuation of actuators 12 may be used as the indication of solar collector orientation. The wind data (including speed, direction, variability) together with the solar collector orientation data allows derivation of the regions of the surface which are expected to have been cleaned by the cleaning elements, and the efficacy of that cleaning. This derivation may be based on computer models of the cleaning effect which, themselves, may be based on a theoretical model or on empirical data, or a combination thereof.

The estimated distribution of dirt on the collector surface is calculated as a difference between the dirt that would otherwise have accumulated on the surface and the dirt that has been removed by the cleaning elements. The rate of accumulation of dirt on the surface can in some circumstances be reasonably approximated by a constant uniform rate of deposition, typically reset at the last “reset event”, which may be taken to be a supplementary (e.g., water-based) cleaning event, a rainstorm which is assumed to have been effective at cleaning the surface, and/or normal operation of the wind-displaced cleaning elements themselves under conditions that are expected to have been highly effective.

A more precise estimate for dirt accumulation may be obtained by employing additional inputs, and in particular, a visibility or pollution sensor 24, which most preferably provides an indication of the level of airborne particulate matter. Humidity levels provided by a humidity sensor 30, together with the current wind conditions and surface orientation, provide a good indication of the likely rate of build-up of such particles as dirt on the surface of the solar collector. Here too, the rates of accumulation can be modeled by computer models, based on theoretical modelling and/or empirical data. As an alternative to one or both of pollution sensor 24 and humidity sensor 30, the corresponding data may be retrieved from networked servers 34, typically from the weather conditions service 36 (e.g., humidity data) and/or from a source of Air Quality Index (AQI) data 38 or another online source of airborne particulate matter data. A rain sensor 28 may also be an advantageous addition to the system, since rain may in certain cases be considered a “reset event” which is effective to remove the majority of dirt from the collector surface. The controller may also respond to sensing of rain together with data of current wind conditions to choose a current cleaning orientation most effective for cleaning of the surface by the rain, and to operate the actuators to bring the collector surface to the corresponding orientation.

As a supplemental, or alternative, source of an indication as to the cleanliness status of each solar collector, an output monitor 42, typically in the form of the power management circuitry of a PV system, preferably provides an indication of the relative power output of each panel, thereby allowing reliable identification of any panel for which the output is significantly reduced compared to other panels of the system. Additionally, or alternatively, absolute output power can be compared with expected output for the currently incident radiation levels and direction, for example, as derived from a radiation direction and intensity sensor 26, thereby allowing assessment of efficiency reduction which impacts performance of all of the panels. It is known that non-uniform distribution of dirt on PV panels can give rise to localized hotspots, and can adversely impact the efficiency of the entire panel. By identifying promptly when such degradation of output occurs, and by taking prompt corrective action by optimizing the panel orientation for the cleaning effect (prioritized over the solar-collection effect), it may be possible return the panel to full efficiency and to avoid potential permanent damage to the panel which could otherwise result from an unresolved hotspot effect.

As a further supplemental, or alternative, source of data indicative of a distribution of dirt on the collector surface, the input dataset includes an image of the collector surface sampled by a camera 32, which may be a dedicated camera mounted on or near each solar collector or group of collectors, or which may be gimbal-mounted camera located at a central vantage point, or a mobile camera mounted on a terrestrial or airborne robot or drone. In this case, controller 16 preferably processes the image(s) to identify regions requiring cleaning.

Some combination of the above-referenced data sources provides the required input dataset for controller 16 to store in one or more data storage device 44 and to process using its one or more processors 18 to derive information as to what part(s) of the solar collector surface(s) currently require enhanced cleaning, and how significant an impact this is having, or is likely to have, on the efficiency of capture of solar power. This information is designated as the current status of the solar collector(s), and the functional module of the controller responsible for generating this current status is designated as “status monitor” 46.

Controller 16 also includes a decision machine module 50, which takes into consideration the “current status” of the solar collector, and decides on a course of action to enhance cleaning. In certain implementations, particularly suitable in scenarios in which levels of dirt accumulation and their impact on efficiency are relatively low, the decision machine can be implemented so as to actuate a cleaning mode only during inactive hours of the solar system (e.g., at night), and to move the solar collector sequentially to one or more orientation chosen to optimize cleaning of the least-well-cleaned region(s) of the surface according to the current wind direction at that time.

In order to provide enhanced flexibility for decision making, controller 16 preferably also includes an output predictor module 48 which predicts the expected outcome of continued operation of the solar collector to collect solar energy under the current status and compares this with the predicted outcome of diverging from the “optimal” tracker behavior in order to enhance the wind-cleaning effect on the collector surface, and the subsequent predicted improved performance of the solar collector. The predictor may evaluate multiple scenarios, which may have differing expectations of the extent of disruption to current solar energy capture and corresponding differing expectations as to the effectiveness of the wind-actuated cleaning. This allows decision machine module 50 to make decisions based on a cost-benefit analysis of different options.

The output predictor module may base its predictions on extrapolation of the currently-detected radiation intensity as provided by sensor 26 together with the known trajectory of the sun across the sky. Additionally, or alternatively, it may receive inputs via networked servers 34 from a weather forecasting service 40. The output predictor may also take into consideration longer-term weather forecast parameters, such as, for example, whether rain is predicted, which may render it unnecessary to disrupt solar collection in order to enhance cleaning, or whether nocturnal wind levels are expected to be insufficient for effective cleaning, which may lead to prioritizing an orientation which enhances cleaning during the windy hours of the day even at the expense of temporary disruption or degradation of solar energy collection.

Controller 16 thus preferably determines or predicts a drop in efficiency of the solar collector due to accumulated dirt and, when an efficiency improvement due to cleaning is expected to outweigh losses due to disruption of normal tracking, interrupts operation of the solar collector to bring the collector to the cleaning orientation.

The status monitor 46, the output predictor 48 and the decision machine 50 are illustrated here as distinct functional modules for ease of presentation. It will be understood, however, that a practical implementation may employ the same hardware, or overlapping hardware, to implement these functions, and that the subdivisions between the different modules need not reflect the functional subdivisions mentioned here. The modules may be implemented using suitable software executed on general purpose processing systems or using dynamically-allocated computing resources in a cloud, or may be implemented using application-specific integrated circuits (ASICs). The processing may be implemented as defined algorithms or logic circuitry, or may employ artificial intelligence (AI) techniques, including self-learning AI.

In certain cases, the analysis performed by controller 16 may generate supplementary recommendations beyond operation of the tracker actuators to enhance wind-displaced cleaning. For example, in some cases, the system may generate a recommendation when a supplementary (e.g., manual) cleaning process should be initiated, or to provide a warning to operators when a potentially-damaging hotspot has not been effectively addressed using tracker-enhanced wind-displaced cleaning alone. All such outputs are represented by block 52 of FIG. 2.

Where image data from camera 32 is available, the other outputs 52 may also include other notifications based on image processing analysis such as, for example, if a wind-displaced cleaning element 100 is broken and needs replacing.

Turning now to the second aspect of the present invention, this relates to a cleaning system for solar collectors which provides advantageous mechanical properties in the mounting of wind-displaceable cleaning elements to minimize localize stress at the attachment points which might lead to tearing and/or facilitates replacement of the cleaning elements. This aspect of the invention is applicable to a wide range of solar collectors, including PV and heliostat tracker systems as described above, PV systems without trackers, and thermal solar systems such as direct solar water-heating panels.

The cleaning systems of the present invention are based on the use of wind-displaceable cleaning elements 100 which flap or flutter in the wind, buffeting the surface of the solar collector and knocking off dirt and dust, thereby keeping the surface clean. The cleaning element may serve a single panel, or more typically, extends across two or more panels, in some cases serving or more panels in a row. A sequence of cleaning elements may be deployed in partially overlapping relation in order to give coverage for longer rows of panels. In some cases, cleaning elements of differing lengths may be deployed to provide complementary areas of coverage so as to provide effective coverage of the entire area of the solar collector(s). (In the case of a system with a tracker mechanism, uniformity of coverage can be enhanced according to the first aspect of the present invention described above.)

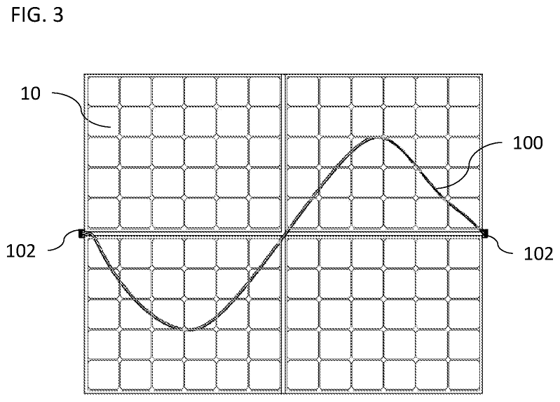

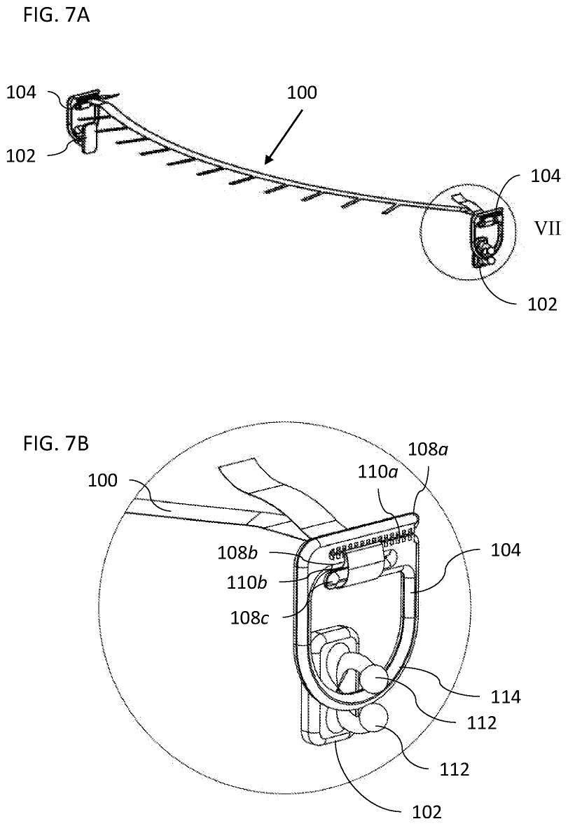

In order to provide a sufficiently lightweight wind-displaceable cleaning element, the cleaning element is typically implemented as a thin ribbon (flexible strip). Optionally, the entire length of the cleaning element may be a uniform ribbon (FIGS. 3, 4A and 8A). Alternatively, the ribbon may be provided with additional cleaning structures spaced along its length, such as branch strips (exemplified in FIG. 7A). These options are interchangeable, throughout this document. In each case, the cleaning element 100 preferably terminates at two ends as a ribbon.

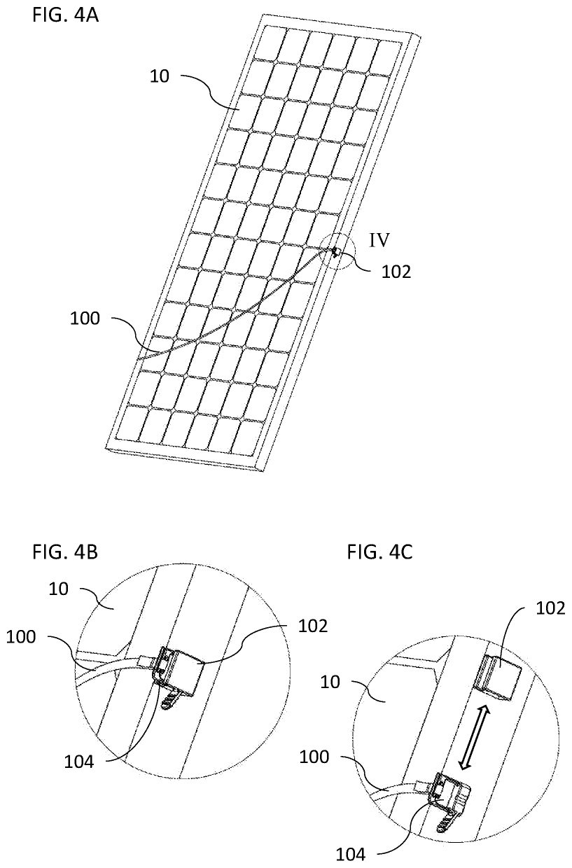

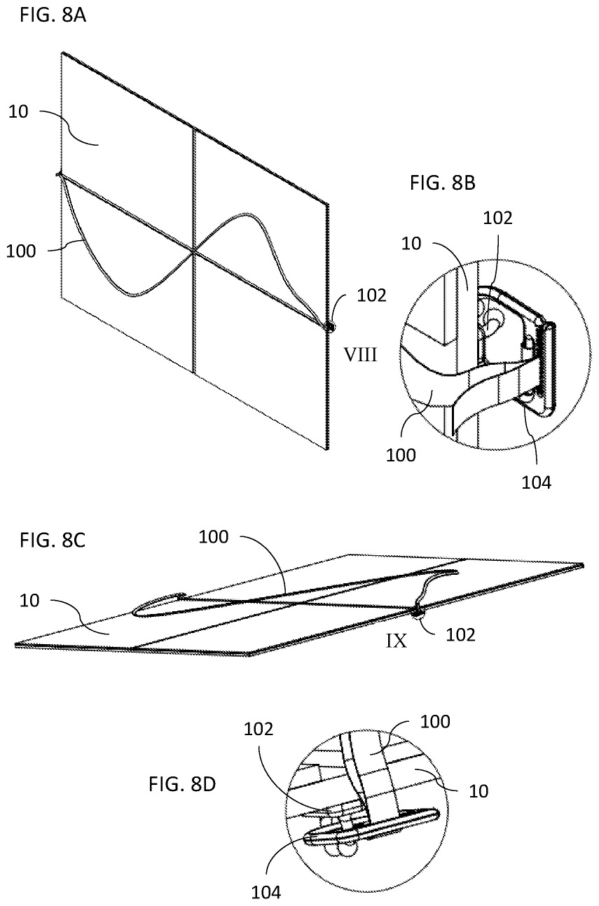

This aspect of the present invention provides advantageous attachment configurations for attaching and detaching such cleaning elements 100 to and from a solar collector 10 so as to facilitate rapid deployment and rapid replacement of the cleaning elements. Specifically, the cleaning system includes a pair of fixtures 102, which are attached to or integrated with the solar collector 10 at spaced-apart locations, chosen to be the anchoring locations for the ends of the cleaning element 100. The fixtures are typically implemented with an adhesive pad on a flat surface for retrofit to a standard solar collector, or may be integrated into the structure of the solar collector during manufacture. The locations for attachment of fixtures 102 are preferably chosen to avoid obstructing sunlight from reaching the solar collector surface, and depend on the form-factor of the collector. In the case of a PV panel with significant thickness, fixtures 102 are advantageously attached to or integrated with side surfaces of the solar collector, as illustrated in FIGS. 4A-4C. In the case of a thin panel or thin reflector of a heliostat system, fixtures 102 are preferably attached to or integrated with a rear surface of the solar collector adjacent to the edges, as illustrated in FIGS. 8A-8D.

In order to facilitate rapid deployment and replacement of cleaning elements 100, each cleaning element is provided with a pair of clips 104, each having a ribbon gripper 106 that grips a corresponding end of the wind-displaceable cleaning element 100. The ribbon gripper may be any suitable gripping arrangement for securely fastening an end of the cleaning element without damaging the ribbon. The cleaning element is preferably provided with a predefined fixed length of the cleaning element between the clips, chosen to be the required length for a given installation (e.g., to be deployed across a certain number of panels of a certain size). Optionally, the ribbon gripper may be implemented in a manner that also allows manual adjustment of the length of the cleaning element between the clips.

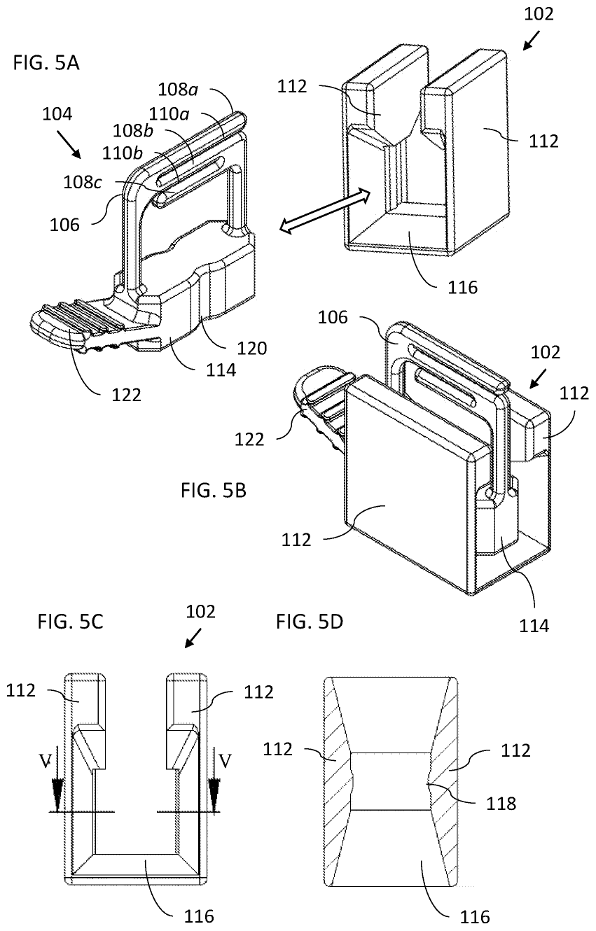

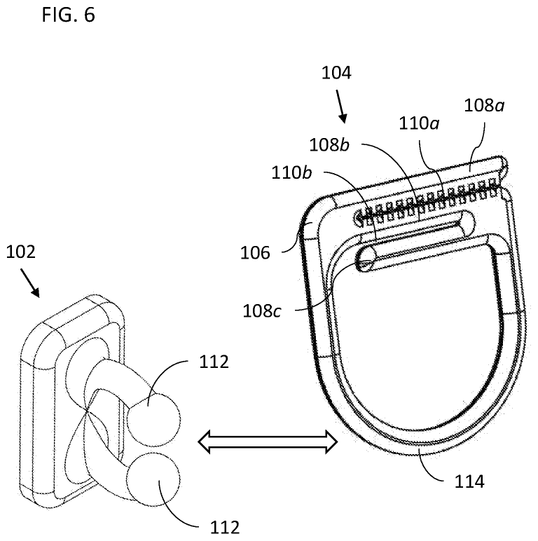

One particularly preferred but non-limiting exemplary implementation of ribbon gripper 106 is best seen in FIGS. 5A and 6 (without the ribbon) and FIGS. 7B and 8B (with the ribbon), where ribbon gripper 106 is formed with three adjacent elongated elements 108a, 108b and 108c, defining between them two ribbon-gripping slots 110a and 110b. The first slot 110a is open at a first end (right-hand-side as viewed in FIGS. 5A and 6), while the second slot 110b is open at a second end (left-hand-side as viewed in FIGS. 5A and 6) opposite from the first end. This allows threading of the ribbon end as illustrated in FIG. 7B, where a loop of the ribbon is slid onto the third elongated element 108c from the left end as shown, passing through second slot 110b, and the double layer of ribbon is then slid into the first slot 110a from the other (right) end. This has been found to result in highly effective clamping of the ribbon end, without slippage, while avoiding the ribbon being pulled against any sharp surface that would be likely to generate a localized region of stress.

Connection and disconnection of clips 104 to and from fixtures 102 is preferably via a releasable attachment configuration, and most preferably a “snap-fit” attachment configuration. In the preferred but non-limiting examples illustrated here, each fixture 102 is provided with a pair of resilient projections 112, and each clip 104 is provided with an engagement portion 114 that can be engaged between resilient projections 112. Any form of engagement which allows attachment by pushing together of two elements with sufficient force to overcome a threshold of resistance and generate momentary resilient (elastic) deformation of one or both of the elements, and which can be disengaged by an oppositely-directed force, is referred to herein as a “snap-fit” attachment configuration. The pair of resilient projections 112 and the engagement portion 114 can be referred to, respectively, as first and second parts of the attachment configuration. Other types of quick-connect attachment configurations which can be detached non-destructively can also be used, including but not limited to, bayonet-type connectors, connectors with resiliently-biased engagement projections, and carabiners.

The cleaning system of this aspect of the present invention is most preferably implemented as a modular system, where the cleaning elements 100 are supplied pre-fitted with their clips 104, and can readily be uninstalled (if broken or worn-out) and a new cleaning element installed by snapping-out the old clips from fixtures 102 and snapping-in the clips of the replacement cleaning element. The fixtures 102 preferably remain installed indefinitely, through multiple cycles of cleaning element replacement.

Most preferably, the orientation of the pair of resilient projections 112 is such that snapping-out (disengagement) of the clip 104 is performed by a motion of the clip relative to the fixture in a release direction chosen such that the inherent tension in the deployed cleaning element and/or any supplemental tension generated by the wind acting of the cleaning device will not disengage the clip. Most preferably, the release direction is chosen such that, when the cleaning device is deployed, tension generated by wind acting on the cleaning device acts on the clips in a direction which has a negative component along the release direction. In other words, during normal operation, tension on the cleaning element will actually oppose disengagement of the clip from the fixture.

Advantageously, the attachment configuration is configured to provide angular freedom of motion of the clip when attached to the fixture, thereby reducing stress on the region in which the ribbon is gripped by the clip as the ribbon undergoes flapping motions. Even a relatively small angular freedom of motion, in the range of at least 10 degrees, and preferably at least 15 degrees, can greatly reduce stress on the ribbon. In certain particularly preferred implementations, such as that illustrated in FIGS. 6-8D, the engagement portion 114 of clips 104 is implemented as a closed loop that engages with the other part of the attachment configuration carried by fixture 102, thereby providing much more extensive angular freedom of motion, typically exceeding 90 degrees.

An alternative implementation of fixture 102 and clip 104 is illustrated in FIGS. 4A-5D. In this case, the resilient projections 112 of fixture 102 are shaped so as to define between them an insertion channel 116 into which engagement portion 114 of clip 104 is inserted. Insertion channel 116 is preferably formed with inwardly-tapering guide surfaces which serve to guide insertion of the clip. Snap-fit retention is achieved by inwardly-projecting features 118 (FIG. 5D) which resiliently engage corresponding lateral recesses 120 (FIG. 5A) of engagement portion 114.

In this case, each clip 104 is also formed with a projecting handle 122 configured to facilitate holding of the clip by a holding tool (not shown) during attachment to, and detachment from, fixture 102. The provision of projecting handle 122 together with the guide surfaces of insertion channel 116 greatly facilitate manipulation of the clips during engagement and disengagement when the installation is not readily accessible to service personnel without use of tools to extend the reach of the person servicing the solar collector system.

It will be appreciated that the above descriptions are intended only to serve as examples, and that many other embodiments are possible within the scope of the present invention as defined in the appended claims.

What is claimed is:

1. A cleaning system with interchangeable wind-displaced cleaning elements for cleaning one or more solar collector, the system comprising:
(a) a pair of fixtures, attached to or integrated with one or more solar collector at spaced-apart locations, each of said fixtures having a first part of an attachment configuration; and
(b) a cleaning device comprising a wind-displaceable cleaning element terminating at each end in a clip having a second part of an attachment configuration configured so as to define together with said first part of an attachment configuration a releasable attachment configuration,
such that the cleaning device is deployable by attaching each clip to a corresponding one of said fixtures and is removable for replacement by detaching the attachment configuration for each clip, thereby facilitating replacement of the cleaning device by another similar cleaning device.

2. The cleaning system of claim 1, wherein said wind-displaceable cleaning element is formed at least in part from a ribbon, and wherein each of said clips comprises a ribbon gripper gripping a corresponding end of said wind-displaceable cleaning element.

3. The cleaning system of claim 2, wherein said ribbon gripper comprises three adjacent elongated elements defining between them two ribbon-gripping slots, a first of said slots being open at a first end and a second of said slots being open at a second end opposite from said first end.

4. The cleaning system of claim 1, wherein the releasable attachment configuration is disengaged by motion of said clip relative to said fixture in a release direction, and wherein, when the cleaning device is deployed, tension in the cleaning device acts on the clips in a direction which has a negative component along said release direction.

5. The cleaning system of claim 1, wherein said fixtures are attached to or integrated with side surfaces of the solar collector.

6. The cleaning system of claim 1, wherein said fixtures are attached to or integrated with rear surfaces of the solar collector.

7. The cleaning system of claim 1, wherein said attachment configuration is configured to provide angular freedom of motion of said clip when attached to said fixture.

8. The cleaning system of claim 7, wherein said second part of the attachment configuration includes a closed loop that is engaged by said first part of the attachment configuration.

9. The cleaning system of claim 1, wherein each of said clips comprises a projecting handle configured to facilitate holding of said clips by a holding tool during attachment to, and detachment from, said fixture.

10. A method of operating a tracker mechanism that supports a solar collector having a collector surface that is cleaned by at least one wind-displaced cleaning element, the tracker including at least one actuator for changing an angular orientation of the solar collector about at least one axis, the tracker further including a controller for controlling the at least one actuator, the controller including at least one processor, the method comprising the steps of:
(a) inputting to the controller a dataset sufficient to identify at least a first region of the collector surface that is less clean than a second region of the collector surface;
(b) inputting to the controller information indicative of current wind conditions;
(c) determining a cleaning orientation of the solar collector that will enhance cleaning of said first region of the collector surface by the at least one wind-displaced cleaning element under the current wind conditions; and
(d) actuating the at least one actuator to bring the solar collector to the cleaning orientation.

11. The method of claim 10, wherein said dataset includes data of wind conditions and corresponding orientations of the solar collector during a period of operation of the tracker mechanism.

12. The method of claim 10, wherein said dataset includes an image of the collector surface, and wherein the controller processes the image to identify the first region.

13. The method of claim 10, wherein the information indicative of current wind conditions is derived from a wind sensor configured to sense wind speed and wind direction.

14. The method of claim 10, wherein the information indicative of current wind conditions is obtained via a communications network from a weather service.

15. The method of claim 10, wherein the controller further receives inputs from at least one sensor from the group consisting of: a humidity sensor; a radiation sensor; and an air quality or pollution sensor.

16. The method of claim 10, wherein the tracker is a single-axis tracker.

17. The method of claim 10, wherein the tracker is a dual-axis tracker.

18. The method of claim 10, wherein the solar collector is a photovoltaic panel.

19. The method of claim 10, wherein the solar collector is a mirror.

20. The method of claim 10, wherein the solar collector is brought to the cleaning orientation exclusively during non-operative hours of the solar collector.

21. The method of claim 10, wherein said dataset includes data sufficient to determine or predict a drop in efficiency of the solar collector due to accumulated dirt, and wherein the controller further comprises a decision-making subsystem configured to interrupt operation of the solar collector to bring the collector to the cleaning orientation when an efficiency improvement due to cleaning is expected to outweigh losses due to disruption of normal tracking.

22. A method of operating a tracker mechanism that supports a solar collector having a collector surface that is cleaned by at least one wind-displaced cleaning element, the tracker including at least one actuator for changing an angular orientation of the solar collector about at least one axis, the tracker further including a controller for controlling the at least one actuator, the controller including at least one processor, the method comprising the steps of:
(a) inputting to the controller information indicative of current wind conditions;
(b) determining a cleaning orientation of the solar collector that will enhance cleaning of the collector surface by the at least one wind-displaced cleaning element under the current wind conditions; and
(c) actuating the at least one actuator to bring the solar collector to the cleaning orientation.
